(19) United States
(12) Patent Application Publication
(10) Pub. No.: US 2014/0104269 A1
(43) Pub. Date: Apr. 17, 2014

(54) ROTATABLE STEREOSCOPIC METHODOLOGY, SYSTEM, DEVICE, AND DISPLAY VIEWABLE IN BOTH PORTRAIT AND LANDSCAPE MODES

(71) Applicant: David Paul Woods, Burke, VA (US)

(72) Inventor: David Paul Woods, Burke, VA (US)

(21) Appl. No.: 13/778,888

(22) Filed: Feb. 27, 2013

Related U.S. Application Data
(60) Provisional application No. 61/712,495, filed on Oct. 11, 2012.
(60) Provisional application No. 61/758,557, filed on Jan. 30, 2013.

(51) Int. Cl. G06T 15/00

(52) U.S. Cl. CPC G06T 15/005
USPC 345/419

(57) ABSTRACT

A stereoscopic display system includes an image display panel, a means to polarize light so as to present two patterns of images whose polarization direction differ by approximately 90 degrees, and a means to change the relationship of image to polarization direction pattern. The images may be perceived as a stereoscopic image by viewing them through glasses having polarizing directions which differ by approximately 90 degrees. The display device may be rotated approximately 90 degrees from a first orientation into a second orientation, and the device is able to change left and right image patterns, polarization patterns, or any combination of the two so it may be viewed as a stereoscopic image using glasses whose left and right lenses are of same polarization direction as the glasses needed for the first orientation.

### CROSS REFERENCE TO PRIORITY APPLICATION

This application claims the priority benefit of U.S. Provisional Patent Applications Ser. No. 61/712,495, filed on Oct. 11, 2012, and Ser. No. 61/758,557, filed on Jan. 30, 2013, the subject matter for which is incorporated herein by reference.

### BACKGROUND OF THE INVENTION

1. Field of the Invention

The present invention relates to a stereo image display technique and methodology, by which 2D or 3D image display may be manually or automatically switched in two display directions.

2. Description of Related Art

As is understood to those of skill in the art, prior art displays, which may be viewed as 2D or 3D images, generally fall into three methods for the display of 3D imagery.

The first method employs polarized light images where the planes for left and right images are rotated by approximately 90 degrees. These polarized left and right images pass through polarized spectacles so that the corresponding image reaches the left and right eye.

A technique described in U.S. Pat. No. 5,894,361 generally shows a display having a pattern of pixels with 90 degree changes in the direction of orientation. However, this reference is limited to one display orientation. As illustrated in FIG. 2 therein, the reference generally shows such a display may only have the 3D display effect in one display direction. For example, the landscape direction and therefore application thereof is limited.

Another related method employs liquid crystal shutter spectacles, which open and close left and right shutters so as to allow the corresponding image to reach the correct eye. However, such displays require the use of bulky and expensive spectacles.

A third prior art technique generally requires no spectacles and utilizes parallax barriers so that only the proper image is seen by each eye. This technique requires that the viewer remain in an optimal location for 3D viewing. Other spectators, however, may not be able to see the 3D imagery clearly. In addition, this technique does not allow for tilting of the display, as is required by some applications.

Prior art illustrates displays which are able to change display direction. These are present in tablets and smart phones. However, they are limited to 2D images except as noted below.

A technique generally shown in U.S. Pat. No. 8,018,536 is a display with a parallax barrier, which allows 3D viewing in portrait and landscape modes. However, this method has the limitations of parallax barriers, requiring the viewer to be in optimal location for 3D viewing. Other spectators may thus not be able to see the 3D imagery clearly. In addition, this reference does not allow for tilting of the display as is required by some applications.

Another technique is generally shown in EU. Pat. No. EP 2394195 A2, which is a display using liquid crystal shutter glasses. These glasses, however, require Bluetooth coordination, and are prone to connection issues as well. They are also bulky and expensive for replacement or multiple viewers. In addition, the glasses, being electronic devices require a source of power and are prone to failure.

There is, therefore, a need for an improved stereo imaging device that overcomes the limitation of the aforementioned devices and techniques of the prior art

### SUMMARY OF THE INVENTION

The present invention is directed to a stereo image display methodology, system, and device, which may switch between a portrait and landscape modes, and may have a 3D display effect in both modes when viewed through the same pair of polarized glasses. These glasses may be lightweight, inexpensive and require no electronic components.

The present invention relates to a stereo image display system or device which may be viewed in two different display directions or orientations. This display device may be viewed in 2D mode in either display direction. It may also have a 3D stereoscopic effect in both display directions.

Furthermore, in the present invention a first or left 3D image presented for viewing through left lens of stereoscopic glasses has the same polarization direction, from the perspective of the viewer, in both display orientations. Also, in the present invention a second or right 3D image presented for viewing through the right lens of stereoscopic glasses has the same polarization direction, from the perspective of the viewer, in both display orientations. This has the advantage of not requiring two sets of alternately polarized glasses when the display is rotated.

In the present invention, the switching from portrait to landscape mode in 3D may be automatic or it may be manually controlled. It may also be locked by the user in either portrait or landscape orientation.

One embodiment of the present invention provides a stereo image display device includes a source of light, a polarizing module, a display direction sensor or switch, an image display unit, and polarized glasses or spectacles. The polarized light of the left image is displayed in a pattern which is polarized so as to pass through the left lens of the glasses. The polarized light of the right image is displayed in a pattern which is polarized so as to pass through the right lens of the glasses. This allows the user to view the image in 3D.

Upon rotation, the orientation sensor senses the new orientation or a manual signal is sent to direct the orientation to be displayed. An automatic or manual signal (if desired) is sent to the image pattern and polarization pattern modules. The polarization pattern is now coordinated with the left and right image pattern so the image is viewable in 3D using the same 3D glasses as if the display were still in the original direction. In one embodiment, a polarization direction associated with the left image is rotated approximately 90 degrees from the original direction. In another embodiment, the left and right image pattern placements may be swapped after display rotation. In this way after change in display direction, the left image is now associated with the polarization direction previously associated with the right image.

Prior displays are generally capable of displaying 2D and 3D images. A prior method involves the use of polarized glasses to view the image in 3D. They are also capable of changing 2D display orientations when the device is rotated from portrait to landscape mode. The present invention, however, combines these two features, and allows both 2D and 3D display in both landscape and portrait display directions. The present invention uses polarized stereoscopic spectacles for viewing the image in 3D. The remapping of left and right images and/or polarization pattern enables the same pair of 3D glasses to be used in both display directions.

As is understood in the art, there are many ways of accomplishing this end. Although there are many variations of placement of parts, image patterns, polarization patterns, different layering of parts, and/or display images which accomplish the same objective, one skilled in the art will be able to readily understand the principles set forth herein and claimed. It should further be understood that the instant invention, described exemplarily through the embodiments below, is not limited to the particular details of these embodiments, but instead by the claims set forth hereinbelow, and includes variations within the scope of the present invention.

### BRIEF DESCRIPTION OF THE DRAWINGS

While the specification concludes with claims particularly pointing out and distinctly claiming the subject matter that is regarded as forming the present invention, it is believed that the invention will be better understood from the following Detailed Description, taken in conjunction with the accompanying Drawings, where like reference numerals designate like structural and other elements, in which:

FIG. 1A is a schematic diagram illustrating an embodiment of a 3D display mechanism applying polarizing glasses.

FIG. 1B is a schematic diagram illustrating a second embodiment of a 3D display mechanism applying polarizing glasses.

FIG. 1C is a schematic diagram illustrating a third embodiment of a 3D display mechanism applying polarizing glasses.

FIG. 1D is a schematic diagram illustrating a fourth embodiment of a 3D display mechanism applying polarized glasses.

FIG. 2 is a schematic diagram illustrating prior art which is limited to one display direction.

FIG. 3 is a schematic diagram illustrating an embodiment where the display patterns are adjusted when the device is rotated.

FIG. 4 is a schematic diagram illustrating an embodiment where the polarization rotational direction pattern is adjusted when the device is rotated, and/or the image pattern is adjusted. It also illustrates many combinations of image pattern or polarization pattern adjustments may produce the desired effect.

FIG. 5 is a schematic diagram illustrating a variety of image patterns.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

As discussed in the Background section hereinabove, various conventional 3D stereoscopic contain displays which are capable of displaying in 2D and 3D modes and which utilize polarizing glasses. These devices are, however, limited to one orientation, as for example a television display.

Handheld devices of the prior art include devices, such as smart-phones and handheld tablet devices, whose landscape and portrait modes are interchangeable by rotating the handheld device through 90 degree rotations. An orientation or motion sensor is used in these devices to automatically switch orientation modes. However, they are limited to 2D display.

Prior art 3D stereoscopic imaging mechanisms either employ fixed quarter phase rotation devices or an electronically-controlled quarter phase rotation mechanism, such as liquid crystals. These mechanisms may be arranged in any pattern so that a left image is produced in 90 degree opposition to a right image. U.S. Pat. No. 5,894,361 shows a checkerboard pattern. However, the prior art also discusses stripe patterns, and various patterns may be used to produce the same effect.

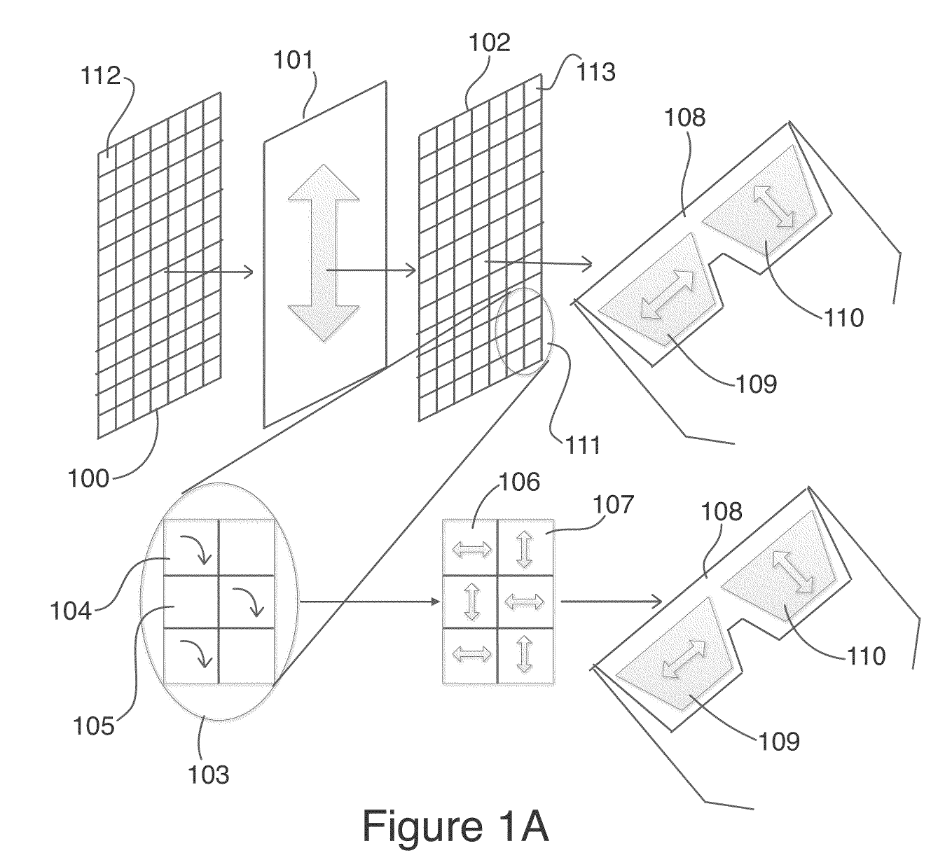

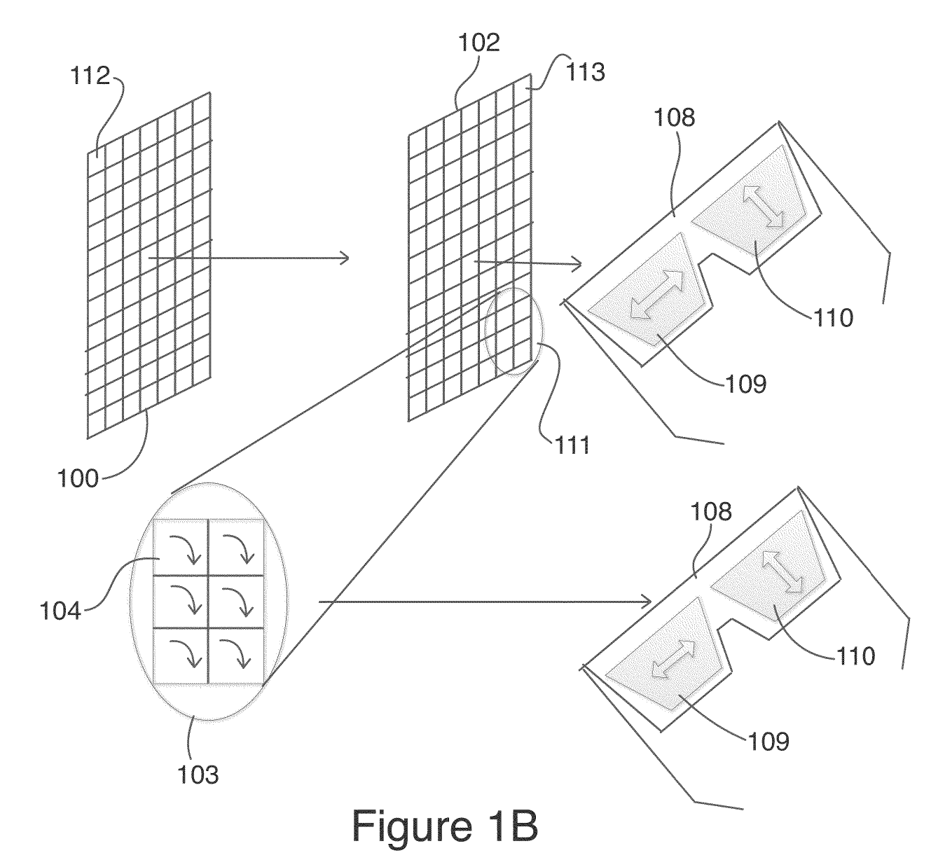

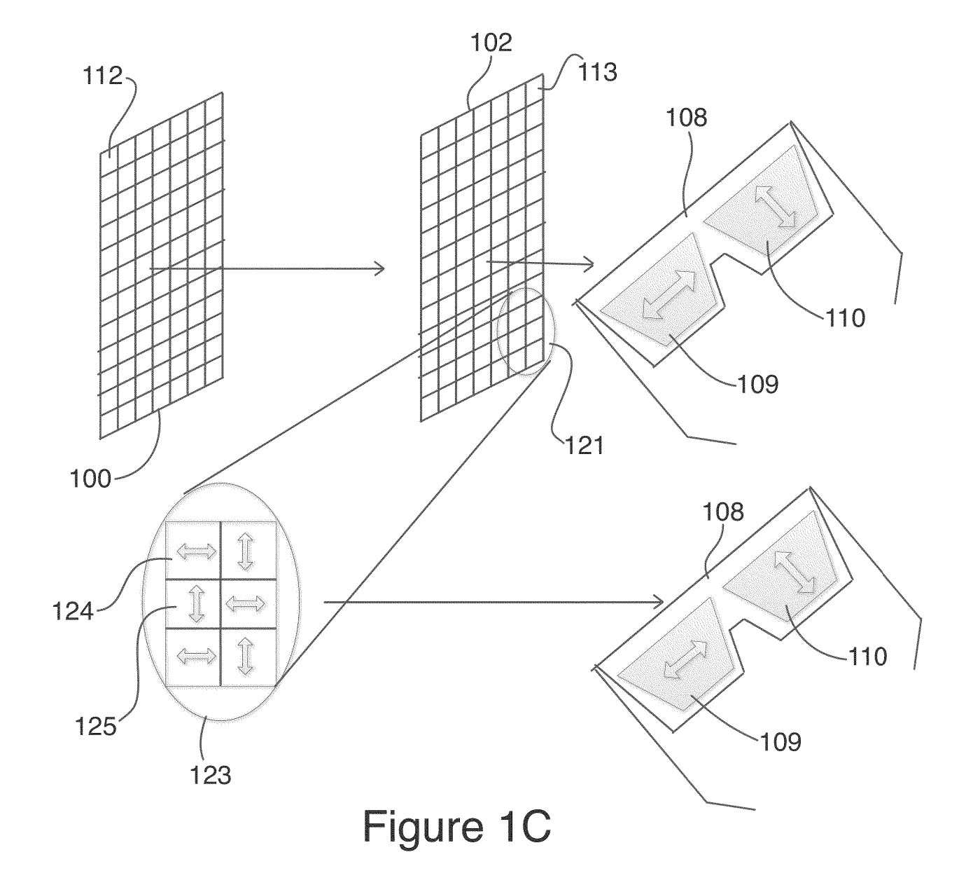

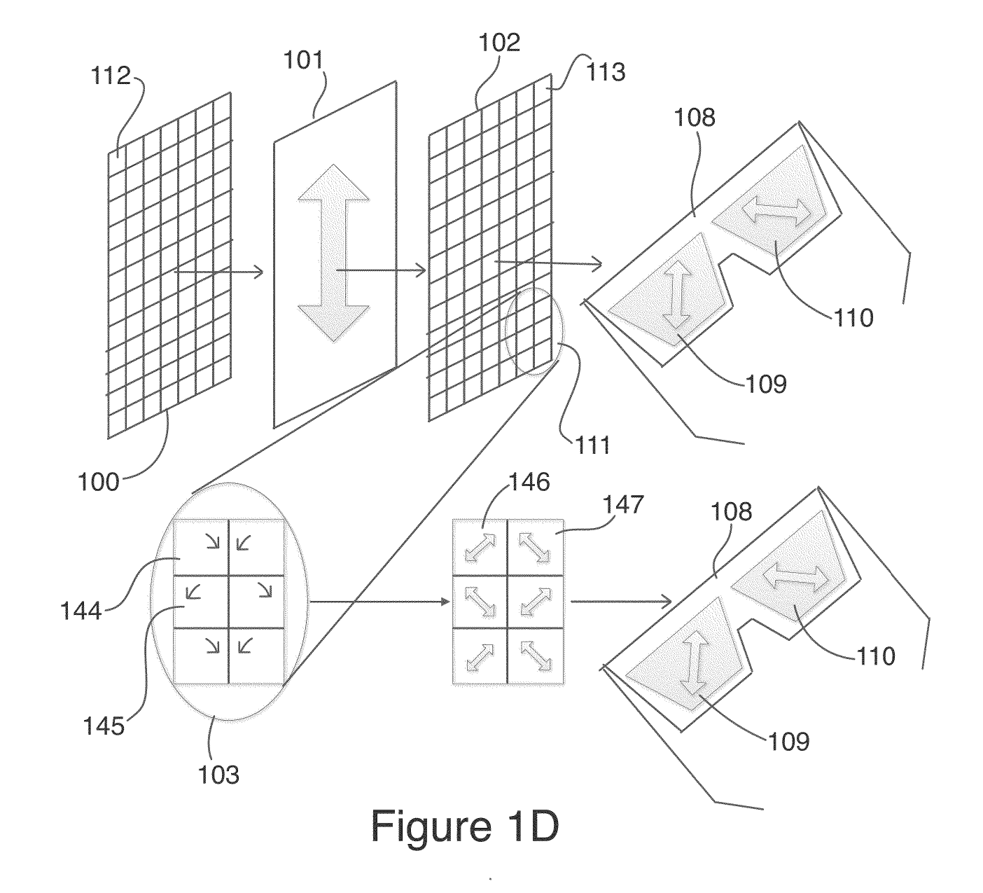

With reference now to FIG. 1 of the DRAWINGS, there is shown a first embodiment of the present invention, utilizing polarization rotators. Said polarization rotators may be of either electronic or non-electronic type. In this embodiment the image patterns and/or polarization direction patterns may be changed from one image refresh to the next, and any combination of patterns resulting in the correct polarization direction for left and right image pixels may be used.

As shown in FIG. 1A, the images are then seen through stereoscopic glasses 108, which have polarizing lenses with about a 90 degree orientation offset, generally designated by the reference numerals 109 and 110, so each eye receives the intended image. A pixel which may be viewed through only the left lens of said polarized glasses may be referred to as a left eye pixel, generally designated by the reference numeral 106. Likewise, a pixel which may be viewed through only the right lens of said polarized glasses may be referred to as a right eye pixel 107.

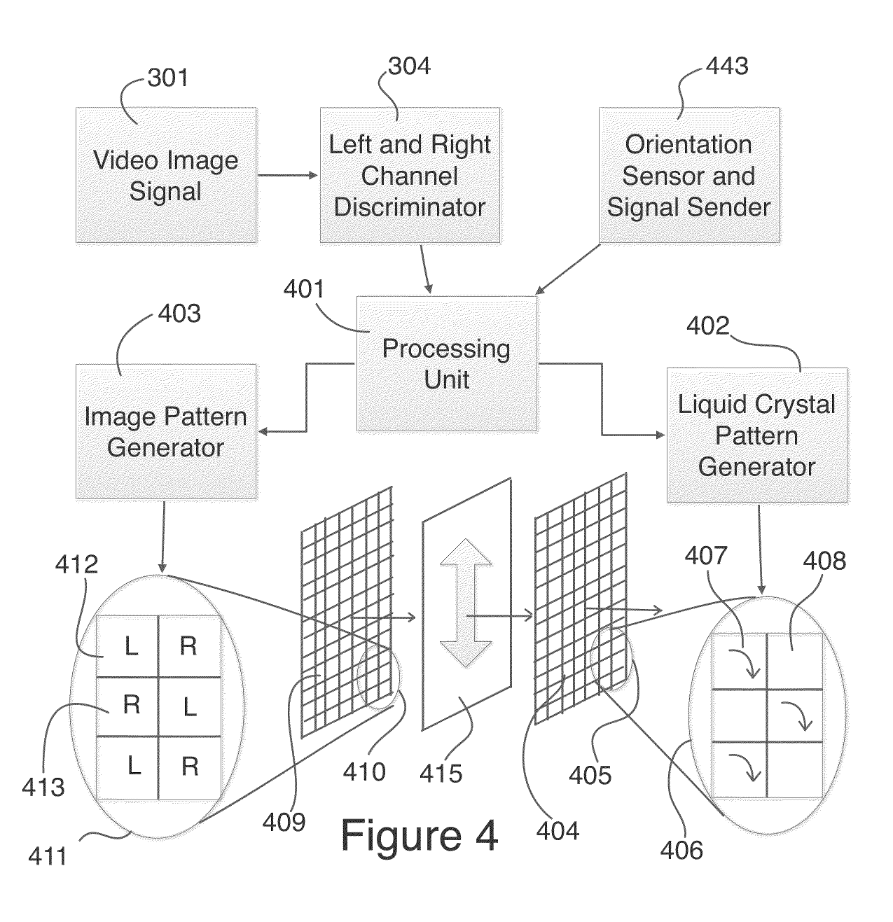

When an image, generally designated by the reference numeral 100, comprised of discrete pixels 112 is generated, it may or may not be polarized, depending on if it was created as LCD, LED, organic, or other display technology. In one embodiment of the present invention, a polarizing sheet, or pattern of polarizers, generally designated by the reference numeral 101, may be employed if the light needs to be initially polarized before passing through a pattern polarizer, generally designated by the reference numeral 102. It should be understood that the pattern polarizer 102 has a number of cells 102A, which contain an electronically-configurable polarization direction rotation or a fixed polarization direction rotation. This is described further hereinbelow in connection with FIG. 4 items 407 and 408, a fixed polarization direction rotation 104, rotated approximately 90 degrees, or a non-rotated polarization direction pass through, generally designated by the reference numeral 105. It should be understood that reference numeral 103 designates an expansion of a small area 111 of the aforementioned polarization direction pattern layer 102.

In this way, for example, the aforementioned left eye pixels item 106 may be viewed through the left eyepiece 109 of the stereoscopic glasses 108 and the right eye pixels 107 may be viewed through the right lens 110 of the stereoscopic glasses.

With reference now to FIG. 1B of the Drawings, there is shown an illustration of an embodiment where the image display panel 100 has a non-polarized light image source. Examples would include, but not be limited by: LED (light emitting diode), organic LED, or electroluminescent displays. In this embodiment, the polarization pattern 102 is composed of individual electronically-controlled polarization direction rotators, e.g., cells 102A. An example for such rotators would be liquid crystal cells, which initially polarize and then are able to rotate the plane of polarization approximately 90 degrees.

A group of polarization cells of electronically-controlled polarization direction, expanded from a small area 111 of the polarization pattern 102, is designated by the reference numeral 103. The pattern of left and right image of item 100 is then matched with the corresponding rotatable cell in proper polarization direction so as to pass through the left or right eyepiece of the glasses 108 so as to produce a stereoscopic effect. When the display is rotated approximately 90 degrees, the image and/or polarization pattern is changed so as to produce the same effect in the new orientation. This embodiment has the advantage of flexibility as either the image or the polarizer pattern may be changed.

With reference now to FIG. 1C of the Drawings, there is illustrated therein another embodiment of the present invention, where the image display 100 has a non-polarized light image. Examples would include, but not be limited by: LED (light emitting diode), organic LED, or electroluminescent displays. In this embodiment, the polarization pattern, generally designated by the reference numeral 122 includes a number of fixed polarizers, including a first or left 124 and a second or right 125 one. The pattern in this embodiment includes polarizers approximately 90 degrees in opposition.

A cross section of an example polarization direction pattern is represented by an expanded portion 121 of the polarization pattern 102, and designated herein with more particularity by the reference numeral 123. The left and right image patterns are controlled by a processing unit and display orientation sensor to output an image 100 pattern, which aligns with the polarization pattern 102 in such a manner so the left image passes through the left lens 109 of the glasses 108 and the right image passes through the right lens 110 of the glasses 108. This embodiment has an advantage of simplicity and is also inexpensive.

With reference now to FIG. 1D of the Drawings, there is illustrated another embodiment of the present invention, where the display image is polarized, as in an LCD for example, or, if the image is unpolarized (as would be the case for LED, or OLED displays for example) it passes through a polarizer 101, or pattern of polarizers, as is understood in the art. The polarization direction pattern of approximately 90 degree offset may then be created by any combination of fixed polarization direction rotators, generally designated by the reference numerals 144 and 145, as shown in the view 103 of the portion 111 of the polarization pattern 102. It should be understood that these rotators may be in any orientation so as to produce this effect.

The instant embodiment illustrates an example where the polarization direction is rotated to the left and to the right by approximately 45 degrees, as shown by the reference numerals 146 and 147. Accordingly, this produces a net effect of approximately 90 degree separation of polarization direction for left and right eye pixels. Thus, when viewed through the aforementioned polarized glasses 108, this produces the desired stereoscopic effect.

Since the angle of rotation of polarization direction is less, this embodiment has the advantage of thinner polarization rotation devices, enabling a thinner display for the device.

It should also be understood that any of the aforementioned parts may be recombined in different combinations, layering, degree of polarization rotation, or sequence of layering so as to produce the same effect.

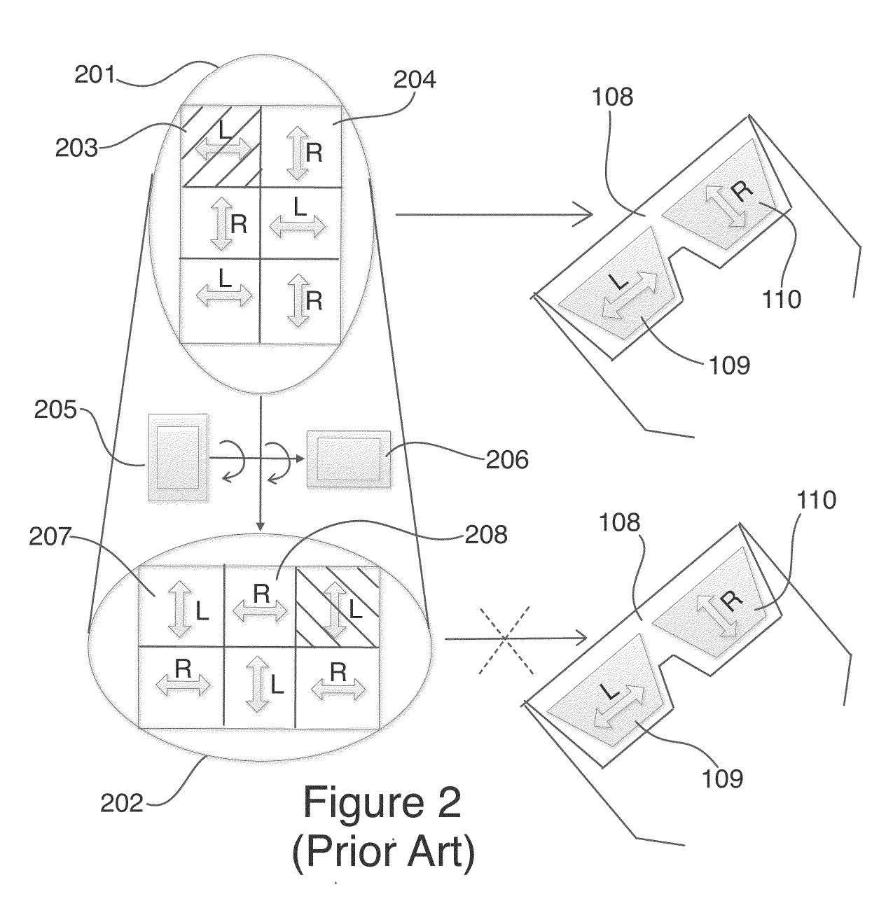

With reference now to FIG. 2 of the Drawings, there is shown a prior art configuration, which is limited to one direction. In conventional polarized glasses, when the display is rotated 90 degrees, from a portrait display 205 and landscape display 206 configurations, the polarization orientation of the pixels (from an expanded section generally designated by the reference numeral 201), the left-oriented or left eye pixels 203 and right-oriented or right eye pixels 204 become reversed, i.e., as shown in FIG. 2, the enhanced section 201 is converted to section 202 after the ninety degree rotation. As is clear, e.g., from the position of the cross-hatched left eye pixels 203 new position to the right, this technique is not oriented so as to be viewed in 3D through the same pair of stereoscopic direction polarized glasses.

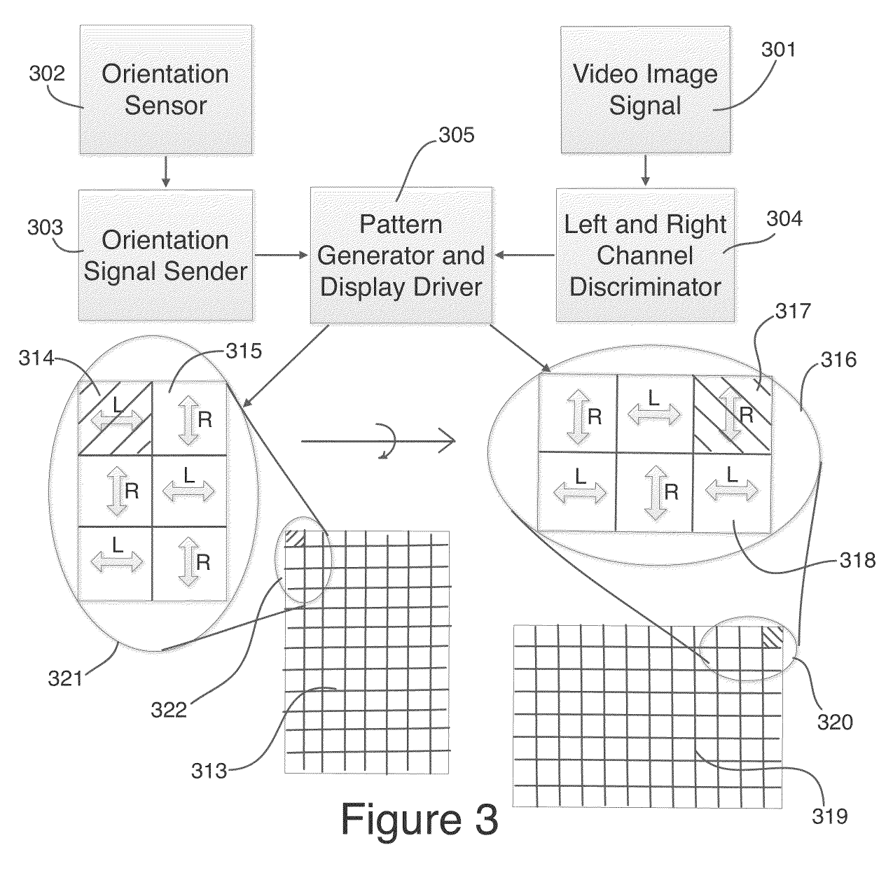

With reference now to FIG. 3 of the Drawings, there is illustrated another embodiment of the present invention, directed to a configuration or means to sense the device display orientation, generally designated by the reference numeral 302. In this embodiment, a signal or message sender 303 sends a message to a display pattern generator 305 to ensure the correct left or right image is then sent to a display, generally designated as a portrait orientation image 313 or a landscape orientation image 319, so as to ensure the aforementioned left eye pixels are viewable through the left lens 109 of the stereoscopic glasses 108 and the right eye pixels are viewable through the right lens 110 of the glasses item 108. For displays where polarizers or polarization rotators are arranged in a fixed array, this is done by moving the pattern from the imaging display, such as image 313, in such a way that the pixel pattern which displayed the left images, such as left-eye pixels 314, after 90 degree rotation, now display the right image, i.e., right-eye pixels 317.

With reference now to FIG. 4 of the Drawings, there is illustrated therein another embodiment of the present invention, where electronic means are used to rotate the direction of polarization. A display orientation sensor, generally designated by the reference numeral 443, sends a signal or software commands to a processing unit 401. One such embodiment employs liquid crystal technology to rotate the direction of polarization. In such an embodiment the aforementioned processing unit 401 or a liquid crystal pattern generator, generally designated by the reference numeral 402 may generate a polarization pattern, generally designated by the reference numeral 404. A cross section 405 of pattern 404 when expanded is shown as section 406.

As shown, some or all of the polarization directions within the pixels of section 406 would be rotated, designated by reference numeral 407, while others would not, designated by reference numeral 408 in FIG. 4. An image pattern generator 403 would create a pattern of left and right images. The left and right image patterns are coordinated with the aforementioned polarization rotators to ensure the left image pattern is viewable through the left eyepiece 109 of the polarized glasses 108 and the right image pattern is viewable through the right eyepiece 110 of the polarized glasses 108.

It should be understood that in this embodiment, the processing unit 401does the coordination, but the parts described are to be interpreted in a generic and descriptive sense only, and not for purpose of limitation. Accordingly, it will be understood many ways of accomplishing this coordination of left and right image to polarization may be made without departing from the spirit and scope of the present invention as set forth in the claims.

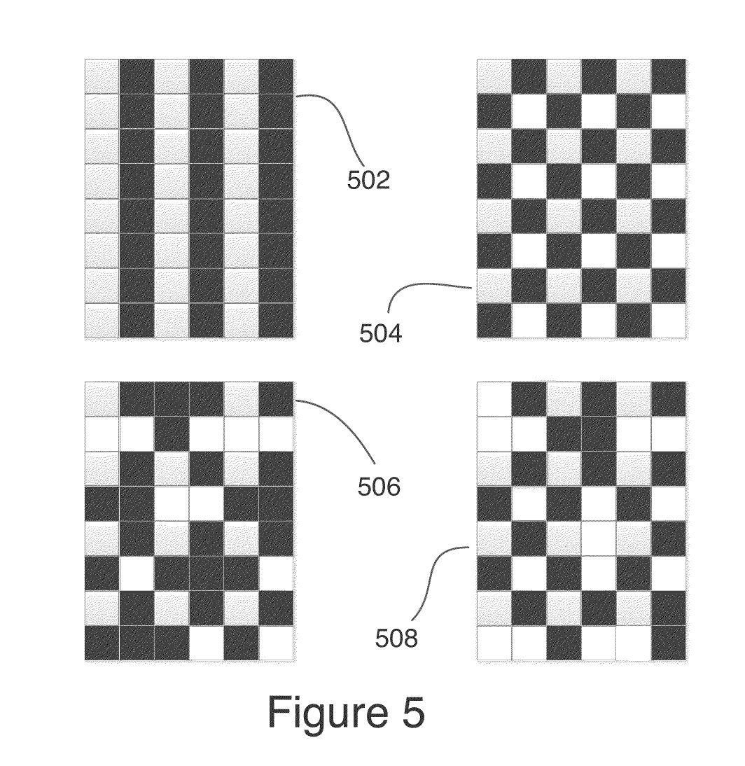

With reference now to FIG. 5 of the Drawings, there are illustrated a small sample of image patterns for left and right images which may be displayed. A striped pattern 502, a checkerboard pattern 504, and random patterns 506 and 508. The dark areas represent a first image and the light areas a second image. Many patterns may be used and these patterns are for illustrative purposes only. Hence they are not intended to be limiting.

Furthermore, although exemplary embodiments have been disclosed herein, and although specific terms are employed, they are used and are to be interpreted in a generic and descriptive sense only, and not for purpose of limitation. Accordingly, it will be understood by those of ordinary skill in the art that various changes in form and details may be made without departing from the spirit and scope of the present invention as set forth in the claims.

By way of conclusion, the prior art in this area of technology encompasses displays having patterns of 90 degree polarization directions, which produce a 3D stereoscopic effect when viewed through wearable polarized glasses. This prior art, such as the references cited herein, is limited to one 3D display orientation.

In other prior art, displays may be rotated approximately 90 degrees so as to present 2D portrait and landscape modes with automatic switching between the modes. An orientation sensor is employed which sends a signal to the display indicating which mode to display. The portrait or landscape 2D modes may also be locked at the convenience of the user. This prior art, however, is limited in being able to only display 2D imagery under portrait and landscape modes.

Utilizing 3D shutter glasses requires the user to employ bulky and expensive shutter glasses which actively open and close shutters. This requires battery power and a complex timing signal to be sent to the shutter glasses to synchronize opening and closing of the shutters. This complexity may tend to make such devices unreliable, prone to breakage, and expensive to repair.

Additional prior art utilizes parallax barriers to obtain 3D stereoscopic effects. There is prior art which enables the parallax barriers to function in different display orientations. However, the parallax barriers limit the eye placement of the viewer to a narrow range. In addition, due to this it is difficult to share viewing or gaming imagery with other viewers. Furthermore there are many applications, which require the user to tilt the image display. An example would be a gaming application, where the image display simulates a surface upon which a ball is rolling and motion sensors in the device cause the ball to roll. Such an application would not be viewable in 3D through parallax barriers when the image display is tilted relative to the eye.

The instant invention improves upon the prior art by allowing a 2D and 3D imaging device, which may be used in both landscape and portrait rotations. This invention uses simple polarized glasses, which are inexpensive, lightweight, and impervious to failure. Furthermore, additional 3D glasses may be made inexpensively. This allows additional users to share in the 3D experience. In addition, the device may be tilted, allowing applications which use motion sensing to operate, all the while maintaining clear 3D imaging.

These and other advantages are readily apparent to one who has viewed the accompanying figures and read the descriptions.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

While the foregoing written description of the invention enables one of ordinary skill to make and use what is considered presently to be the best mode thereof, it should be understood that various changes, substitutions and alterations can be made herein without departing from the spirit and scope of the invention as defined by the appended claims. Therefore, the invention is not to be limited by the above described embodiment, method, and examples, but by all embodiments and methods within the scope and spirit of the invention as claimed.

I claim:

1. A stereoscopic image display system comprising:
a display panel on which first and second eye pixel patterns are defined to display corresponding first and second image patterns having polarization directions which are different by approximately 90 degrees,
and stereoscopic glasses on which a first lens allows polarized light to pass that is of a direction approximately 90 degrees to the polarization direction allowed to pass through a second lens,
and a means to coordinate said first and second image patterns of the display, whereby left and right images that together form a 3D image may be seen in both the landscape and portrait mode with correct optical association when said display is viewed through said glasses.

2. The image display system according to claim 1, wherein the portrait or landscape mode is switched automatically by sensors in the display device without the need for manual switching.

3. The image display system according to claim 2 wherein the sensor is a display orientation sensor.

4. The image display system according to claim 3 wherein the orientation sensor is an accelerometer.

5. The image display system according to claim 4 wherein the accelerometer senses its orientation based on gravity.

6. The image display system according to claim 1, wherein a 2D or a 3D mode of operation is switched automatically based on the format of the image displayed.

7. The image display system according to claim 6, wherein a 2D or 3D mode of operation may be manually locked.

8. The image display system according to claim 6, wherein a 2D or 3D mode of operation may be manually controlled.

9. The image display system according to claim 2, wherein the landscape or portrait mode may be manually locked.

10. The image display system according to claim 2, wherein the landscape or portrait mode may be manually controlled.

11. The image display system according to claim 1, wherein the image patterns are changed for pixels corresponding to left and right images depending on display orientation.

12. The image display system according to claim 1, wherein polarization direction patterns are changed for pixels corresponding to left and right images depending on display orientation.

13. The image display system according to claim 1, wherein the image patterns and the polarization patterns are changed for pixels corresponding to left and right images depending on display orientation.

14. The image display system according to claim 1, wherein the display panel is a liquid crystal display device.

15. The image display system according to claim 1, wherein the display panel is an electroluminescent display device.

16. The image display system according to claim 1, wherein the display panel is an LED or light emitting display device.

17. The image display system according to claim 1, wherein the display panel is an organic light emitting display device.

18. The image display system according to claim 1, wherein the display panel is a plasma display device.

19. The image display system according to claim 1, wherein the left and right eye pixels comprise three sub-pixels of red, green, and blue in landscape mode.

20. The image display system according to claim 1, wherein the left and right eye pixels comprise three sub-pixels of red, green, and blue in portrait mode.

21. The image display system according to claim 1, wherein landscape image data is input to left and right eye pixels in the landscape mode, and portrait image data different from the landscape image data is input to the left and right eye pixels in the portrait mode.

22. The image display system according to claim 1, further comprising
directional polarizer means for said respective polarization directions,
whereby said directional polarizers are arranged in a fixed pattern.

23. The image display system according to claim 1, further comprising:
directional polarization rotators in said pixel patterns,
wherein said directional polarization rotators are arranged in a pattern.

24. The image display system according to claim 23, wherein the directional polarization rotators are electronically controlled.

25. The image display system according to claim 23, wherein the directional polarization rotators are arranged in a fixed pattern.

26. The image display system according to claim 1, wherein the percentage of left eye pixels or right eye pixels displayed at any time may vary from zero to one hundred percent of the display.

27. The image display device of claim 26 wherein the percentage of left eye pixels and right eye pixels displayed at any time are substantially equal.

28. The image display system of claim 1 wherein each refresh of said display generates a new pattern of left and right eye pixels.

29. A method for viewing a 3D image in either portrait or landscape mode, comprising:
a. providing a display panel wherein left and right eye associated pixel patterns are organized to display left and right image patterns in association with organized pixel polarizers with directions which differ by approximately 90 degrees, and
b. coordinating said left and right image patterns of the display,
c. whereby a 3D image may be seen in both the landscape and portrait mode when said display panel is viewed through stereoscopic glasses on which the left lens allows polarized light to pass of a direction approximately 90 degrees from the polarization direction allowed to pass through the right lens glasses.
